(19) United States
(12) Patent Application Publication
(10) Pub. No.: US 2016/0362598 A1
(43) Pub. Date: Dec. 15, 2016

(54) DECREASING CORROSION ON METAL SURFACES

(71) Applicant: BAKER HUGHES INCORPORATED, Houston, TX (US)

(72) Inventors: Zhengwei Liu, Houston, TX (US); Tracey Spann Jackson, Sugar Land, TX (US); Sunder Ramachandran, Sugar Land, TX (US)

(73) Assignee: BAKER HUGHES INCORPORATED, Houston, TX (US)

(21) Appl. No.: 15/174,241

(22) Filed: Jun. 6, 2016

Related U.S. Application Data
(60) Provisional application No. 62/173,705, filed on Jun. 10, 2015.

(51) Int. Cl. C09K 8/54; E21B 43/25; E21B 21/06

(52) U.S. Cl. CPC C09K 8/54; E21B 21/062; E21B 43/25; C09K 2208/32

(57) ABSTRACT

A corrosion inhibitor additive may be circulated in a subterranean formation in an effective amount to decrease metal corrosion in a high temperature environment. The corrosion inhibitor additive may include at least one first inhibitor and at least one second inhibitor. The second inhibitor(s) may include imidazolines, quaternary amines, phosphate esters, and combinations thereof. The first inhibitor(s) may have one of the following formulas:

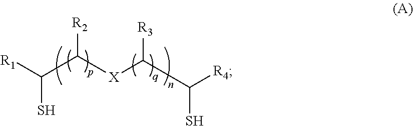

wherein x is oxygen or hydrogenated nitrogen or quaternized nitrogen; R₁, R₂, R₃ and R₄ are independently hydrogen, methyl or an alkyl group; p, q and n are integers from 1 to 100; and

SH—CH₂—[CH₂—O—CH₂]_{z}—CH₂—SH (A1)

where z is an integer ranging from 1 to 100.

### CROSS-REFERENCE TO RELATED APPLICATION

This application claims the benefit of U.S. Provisional Patent Application Ser. No. 62/173,705 filed Jun. 10, 2015, incorporated herein by reference in its entirety.

### TECHNICAL FIELD

The present invention relates to decreasing the corrosion rate of a mild steel surface by incorporating a corrosion inhibitor additive in oil and gas production or treating as a batch to create a film on metal surface. This invention may be used in wells and pipelines that produce oil and gas. It also may be used in transportation pipelines and refinery applications.

BACKGROUND

It is widely known that metal surfaces, such as ferrous and non-ferrous and respective alloys, are subject to corrosion under certain circumstances. As used herein, ferrous metals include, in some non-limiting embodiments, iron and steel. Corrosion is generally defined as any deterioration of essential properties in a material due to chemical interaction with its environment, and in most situations it is considered to be undesirable. The result of corrosion is usually formation of an oxide and/or a salt of the original metal. In most cases corrosion comprises the dissolution of a material. It may also be caused by exposure to corrosive chemicals, including, for example, acids, bases, dehydrating agents, halogens and halogen salts, organic halides and organic acid halides, acid anhydrides, and some organic materials such as phenol.

To combat corrosion, any susceptible metal may be treated, contacted, and/or surrounded with a corrosion inhibitor. Susceptible metal surfaces may be those having a thermodynamic profile relatively favorable to corrosion. Because the efficacy of any particular corrosion inhibitor is generally known to be dependent upon the circumstances under which it is used, a wide variety of corrosion inhibitors have been developed and targeted for use. One target of great economic interest is the treatment of crude oil and gas systems, for protecting the variety of metal surfaces, e.g. ferrous, non-ferrous, or otherwise, needed for obtaining and processing the oils and gases. Oil and gas systems are defined as including metal equipment in a subterranean formation as well as on the surface, including piping, tubing, tools and other metal surfaces, along with those leading to and in a petroleum refinery. Such metal surfaces are present in oil and gas wells, including, for example, production and gathering pipelines, where the metal surfaces may be exposed to a variety of acids, acid gases, such as CO₂ and H₂S, bases, and brines of various salinities. Other applications include industrial water treatments, construction materials, coatings, and the like. In some cases the corrosion inhibitors are desirably tailored for inhibiting specific types of corrosion, and/or for use under particular conditions of temperature, pressure, shear, and the like, and/or for inhibiting corrosion on a generalized or localized basis.

A number of corrosion inhibitors featuring sulfur-containing compounds have been described. For example, U.S. Pat. 5,863,415 discloses thiophosphorus compounds of a specific formula to be particularly useful for corrosion inhibition in hot liquid hydrocarbons and may be used at concentrations that add to the fluid less of the catalyst-impairing phosphorus than some other phosphorus-based corrosion inhibitors. These thiophosphorus compounds also offer the advantage of being able to be prepared from relatively low cost starting materials.

Other sulfur-containing compounds are disclosed in, for example, U.S. Pat. No. 5,779,938, which describes corrosion inhibitors that are reaction products of one or more tertiary amines and certain carboxylic acids, preferably a mixture of mercaptocarboxylic and carboxylic acids. The use of sulphydryl acid and imidazoline salts is disclosed as inhibitors of carbon corrosion of iron and ferrous metals in WO 98/41673. Corrosion of iron is also addressed in WO 99/39025, which describes using allegedly synergistic compositions of polymethylene-polyaminodipropion-amides associated with mercaptoacids. A number of specific sulfur-containing compounds are currently in commercial use as corrosion inhibitors for certain types of systems.

Such corrosion inhibitors have not been satisfactory in decreasing corrosion in some high temperature environments. Thus, it would be desirable if methods and/or corrosion inhibitors for decreasing corrosion of metal surfaces within a subterranean formation during a downhole operation could be improved, but as well as in other contexts.

### SUMMARY

There is provided, in one form, a method for decreasing corrosion of a metal surface in a corrosive environment where less corrosion of the metal surface occurs as compared to an otherwise identical method absent the corrosion inhibitor additive. The method may include incorporating a corrosion inhibitor additive into the corrosive environment, including but not necessarily limited to within an oil and gas production system, in an effective amount based on the total amount of the corrosive fluid to at least partially decrease corrosion of the metal surface. A corrosion inhibitor formulation may include at least one first inhibitor with or without a second or more inhibitors. The first inhibitor(s) may be represented by the following general formula:

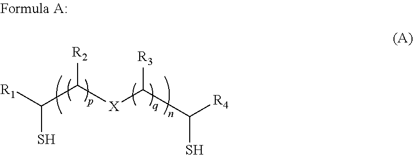

wherein x is oxygen or hydrogenated nitrogen or quaternized nitrogen; R₁ and R₂ are hydrogen, methyl or an alkyl group, n is an integer from 1 to 100. One specific form of Formula A is represented by Formula Al wherein z is an integer ranging from 1 to 100. The Formula Al may be included in the corrosion inhibitor additive in addition to or in lieu of the first inhibitor(s) in a non-limiting embodiment.

SH—CH₂—[CH₂—O—CH₂]_{Z}—CH₂—SH (A1)

### BRIEF DESCRIPTION OF THE DRAWINGS

FIG. 1 is a graph of corrosion rate as a function of time for a first corrosion inhibitor of Formula Al at a dosage of 1 ppmv and 10 ppmv; and

FIG. 2 is a graph of corrosion rate as a function of time for a first corrosion inhibitor for a first corrosion inhibitor of Formula A1 of FIG. 1 that is unaged, and which is aged at the indicated temperatures.

### DETAILED DESCRIPTION

It has been discovered that corrosion of metal surfaces in a high temperature environment may be decreased, prevented, and/or inhibited by introducing a corrosion inhibitor additive into a corrosive environment in an effective amount based on the total amount of the corrosive environment to at least partially decrease corrosion of the metal surface. The corrosion inhibitor additive may include at least one first or primary inhibitor and may have other additional or second inhibitors. With the aid of the corrosion inhibitor additive, less corrosion of the metal surface occurs as compared to an otherwise identical method absent the corrosion inhibitor additive. The corrosion inhibitor additive and/or individual components and/or the corrosion inhibitor mentioned below may be used in offshore applications, such as but not limited to decreasing corrosion to pipelines and/or wellhead structures.

“System” is defined herein to be a subterranean system that includes a fluid and any components therein (e.g. pipes or conduits where the downhole fluid may flow through or alongside). In one non-limiting embodiment the system may be defined as any corrosive environment having a metal surface in physical contact with a production fluid. In a non-limiting example, if the system includes a packer fluid then the method applies to decreasing corrosion of any metal in contact with the packer fluid. The system may include a downhole fluid composition that may have or include an aqueous-based fluid, a non-aqueous-based fluid, corrosion forming components, corrosion inhibitor additives and/or individual corrosion inhibitors, and combinations thereof. In a non-limiting embodiment, the downhole fluid may be circulated through a subterranean formation, such as a subterranean reservoir wellbore, during a downhole operation. The downhole operation may be or include, but is not limited to, a drilling operation, a completions operation, a stimulation operation, an injection operation, a servicing or remedial operation, and combinations thereof. In the instance the corrosion inhibitor additive and/or corrosion inhibitor (Formula A) are circulated into the subterranean reservoir wellbore at the same time as the downhole fluid, the corrosion inhibitor additive and/or corrosion inhibitor (Formula A) may be added to the downhole fluid prior to the circulation of the downhole fluid into the subterranean formation or wellbore.

A drilling operation is used to drill into a subterranean reservoir formation, and a drilling fluid accompanies the drilling operation. A completions operation is performed to complete a well, such as the steps and assembly of equipment (e.g. downhole tubulars) to bring a well into production once the drilling operations are done. A stimulation operation is one where a treatment is performed to restore or enhance the productivity of a well, such as hydraulic fracturing (above the fracture pressure of the reservoir formation) and matrix treatments (below the fracture pressure of the reservoir formation). An injection operation includes a well where fluids are injected into the well, instead of produced therefrom, to maintain reservoir pressure therein. A servicing operation allows for maintenance to the well during and/or after the well has been completed and/or produced, enhancing the well productivity, and/or monitoring the performance of the well or reservoir.

Each downhole operation has its own respective downhole fluid, e.g. drilling operations utilize drilling fluids. Downhole fluids are typically classified according to their base fluid. In aqueous based fluids, solid particles are suspended in a continuous phase consisting of water or brine. Oil can be emulsified in the water, which is the continuous phase. “Aqueous based fluid” is used herein to include fluids having an aqueous continuous phase where the aqueous continuous phase can be all water, brine, seawater, and combinations thereof; an oil-in-water emulsion, or an oil-in-brine emulsion; and combinations thereof. For example, brine-based fluids are aqueous based fluids, in which the aqueous component is brine. “Brine” is defined as a water-based fluid comprising salts that have been controllably added thereto. “Seawater” is similar to brine, but the salts in the seawater have been disposed therein by a natural process, e.g. ocean water is a type of seawater that formed in the absence of any man-made intervention.

Non-aqueous based fluids, also known as oil-based fluids, are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in-non-aqueous emulsion, a brine-in-oil emulsion, a brine-in-non-aqueous emulsion, a seawater-in-non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

The first inhibitor(s) may be represented by the following general formula:

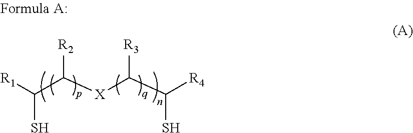

wherein x is oxygen or hydrogenated nitrogen or quaternized nitrogen; R₁, R₂, R₃ and R₄ are independently hydrogen, methyl or an alkyl group; n, p and q are integers from 1 to 100. In one non-limiting embodiment the alkyl group is defined as having from 1 independently to 100 carbon atoms; alternatively from 1 independently to 10 carbon atoms.

One specific form of Formula A is represented by Formula Al wherein z is an integer ranging from 1 to 100. The Formula Al may be included in the corrosion inhibitor formulation in addition to or in lieu of the first inhibitor(s) in a non-limiting embodiment.

SH—CH₂—[CH₂—O—CH₂]_{z}—CH₂—SH (A1)

Other, second or secondary inhibitors that can be used with Formula A can be primary amines, secondary amines, tertiary amines, quaternary amines, imidazolines and derivatives, phosphate derivatives, thiol derivatives, pyridine derivatives, organic acids, fatty acids, alkyl alcohols, surfactants, oxygen scavengers and scale inhibitors. Suitable imidazoline derivatives include, but are not necessarily limited to, ethoxylated imidazolines, polymerized imidazolines, imidazolines with amine tails (alkylene chains terminated by amine functionality), imidazolines with hydroxyl tails (alkylene chains terminated by hydroxyl functionality functionality), imidazolines with thiol tails (alkylene chains terminated by thiol functionality), and the like. Suitable thiol derivatives include but are not necessarily limited to, 2 mercaptoethanol and the like, Suitable pyridine derivatives include, but are not necessarily limited to, alkyl pyridine and quarternized alkyl pyridine salts and the like. Suitable organic acids include, but are not necessarily limited to, dodecyl succinic acids, dimer, trimer acid, linoleic acid, and the like. Suitable alkyl alcohols include, but are not necessarily limited to, propargyl alcohol and the like. Suitable surfactants include, but are not necessarily limited to, nonyl phenol ethoxylate, betaines, sultaines, hydroxy sultaines, and the like. Suitable oxygen scavengers include, but are not necessarily limited to, metal catalyzed ammonium bisulfite, and the like. Suitable scale inhibitors include, but are not necessarily limited to, phosphonates, phosphate esters, and the like. In all cases for the second inhibitor, the alkyl group or alkylene chain may have from 1 independently to 12 carbon atoms; alternatively from 2 independently to 8 carbon atoms.

Without wishing to be limited by temperature, Formula A can be used in high temperature environments. The temperature of the “high temperature” environment be above 100° F. (38° C.), may range from about 150° F. (66° C.) independently to about 500° F. (260° C.), alternatively from about 200° F. (93° C.) independently to about 450° F. (232° C.), or from about 300° F. (149° C.) independently to about 400° F. (204° C.). Thus, the corrosion inhibitor additive, or its individual components, may be stable at a temperature ranging from about 150° F. (66° C.) independently to about 500° F. (260° C.), alternatively from about 250° F. (121° C.) independently to about 450° F. (232° C.), or from about 300° F. (149° C.) independently to about 400° F. (204° C.).

Formula A will also prevent corrosion in environments at low temperatures from 35° F. (1.7° C.) to 150° F. (66° C.).

“Stable” as defined herein means the corrosion inhibitor additive may begin to decompose after a pre-determined amount of time, a change in temperature or pressure, etc. However, the corrosion inhibitor additive remains at least 60% functionally effective, alternatively 50% functionally effective, or about 30% functionally effective in another non-limiting embodiment. “Functionally effective” is defined to mean the ability of the corrosion inhibitor additive to decrease corrosion of a metal surface in a high temperature environment, i.e. up to about 500° F. (260° C.).

Performance of a given corrosion inhibitor additive and/or individual corrosion inhibitors may be tested using any of a variety of methods, such as those specified by the American Society for Testing Materials (ASTM) or NACE International (NACE). One effective method to test the performance of a corrosion inhibitor additive and/or individual corrosion inhibitors under conditions of moderate shear, involves a rotating coupon electrochemical technique described in ASTM: Standard Guide for Evaluating and Qualifying Oilfield and Refinery Corrosion Inhibitors in the Laboratory (Designation ASTM G170-01a), and also in NACE Publication 5A195, Item No. 24187, “State of the Art Report on Controlled-Flow Laboratory Corrosion Tests.” In this test, various concentrations of inhibitor chemistries are introduced into a given perspective corrosive environment. The coupons are then rotated at high speed in the environment to generate moderate shear stress on the metal surfaces. Electrochemical techniques, such as, for example, linear polarization resistance (LPR), are then employed under these moderate shear conditions, to monitor the prevailing general corrosion rate as well as to identify instances of localized corrosion. A concentration profile is then generated to establish the minimum effective concentration of the corrosion inhibitor additive and/or individual corrosion inhibitors that is required to adequately protect the coupon at an acceptable corrosion rate.

The effective amount of the corrosion inhibitor additive may range from about 0.01 ppmv independently to about 1,000 ppmv based on the amount of total produced fluids, alternatively from about 10 ppmv independently to about 1,000 ppmv, or from about 100 ppmv independently to about 500 ppmv. The molar ratio of the first inhibitor(s) to the second inhibitor(s) within the corrosion inhibitor additive may range from about 1:2 independently to about 2:1, alternatively from about 1:10 independently to about 10:1, or from about 1:100 independently to about 100:1 in another non-limiting embodiment. As used herein with respect to a range, “independently” means that any threshold may be used together with another threshold to give a suitable alternative range, e.g. about 10 ppmv independently to about 1,000 ppmv is also considered a suitable alternative range for the amount of the corrosion inhibitor additive components.

In a non-limiting embodiment, the fluid may include dissolved solids or salt species which can provide conductivity to transfer electrons or they may form protective or destructive scales. The methods and compositions described herein are expected to be useful in these environments susceptible to scale formation. These species are present as a consequence of the dissolution of the oil and gas subsurface geological formation or by consuming electrons from steel pipe via iron oxidation process or by the reaction of gases with the constituents in the aqueous solution. These species range in concentration from about 10 ppm independently to about 300,000 ppm based on the total volume of the fluid, alternatively from about 100 ppm independently to about 10,000 ppm, or from about 500 ppm independently to about 5,000 ppm.

The salt species may have or include, but are not limited to, metal carbonates, metal sulfates, metal oxides, metal phosphates, metal sulfides and combinations thereof. The retention of the respective salt constituents in ionic form, i.e. the solubility, depends upon such factors as water temperature, pH, ion concentration, and the like. The metal of the corrosion causing components may be or include, but is not limited to calcium, magnesium, barium, iron, zinc, and combinations thereof.

The corrosion inhibitor additive and/or individual corrosion inhibitor may be introduced into the environment to which the corrodible material will be, or is being, exposed. Such environment, which includes some proportion of water, may be, in certain non-limiting embodiments, a brine, a hydrocarbon producing system such as a crude oil or a fraction thereof, or a wet hydrocarbon containing gas, such as may be obtained from an oil and/or gas well. The corrosion inhibitor additive and/or individual corrosion inhibitors may be, prior to incorporation into or with a given corrosive environment in liquid form.

Incorporation of the corrosion inhibitor additive and/or individual corrosion inhibitors into the corrosive and high temperature environment may be by any means known to be effective by those skilled in the art. Simple dumping, such as into a drilling mud pit; addition via tubing in a suitable carrier fluid, such as water or an organic solvent; injection; or any other convenient means may be adaptable to these compositions. Large scale environments such as those that may be encountered in oil production, combined with a relatively turbulent environment, may not require additional measures, after or during, to ensure complete dissolution or dispersal of the corrosion inhibiting composition. In contrast, smaller, less turbulent environments, such as relatively stagnant settling tanks, may benefit from mechanical agitation of some type to optimize the performance of the corrosion inhibiting composition; however, such mechanical agitation is not required. Those skilled in the art would be readily able to determine appropriate means and methods in this respect.

In a non-limiting embodiment, a downhole fluid may be injected into the bottom of a well at a time selected from the group consisting of: prior to incorporating the corrosion inhibitor additive and/or the corrosion inhibitor (e.g. Formula A), after the incorporating the corrosion inhibitor additive and/or the corrosion inhibitor (e.g. Formula A), at the same time as incorporating the corrosion inhibitor additive and/or the corrosion inhibitor (e.g. Formula A), and combinations thereof. The downhole fluid may be or include, but is not limited to, a downhole fluid selected from the group consisting of drilling fluids, completion fluids, stimulation fluids, packer fluids, injection fluids, servicing fluids, and combinations thereof.

The corrosion inhibitor additive and/or the corrosion inhibitor (e.g. Formula A) may contact a metal surface for decreasing the corrosion of the metal surface. The metal surface may be or include, but is not limited to, a ferrous metal surface, a non-ferrous surface, alloys thereof, and combinations thereof. In certain non-limiting embodiments, examples of the metal within the metal surfaces may have or include, but not be limited to, commonly used structure metals such as aluminum; transition metals such as iron, zinc, nickel, and copper; steel; alloys thereof; and combinations thereof. In a non-limiting embodiment, the metal surface may be painted and/or coated.

In one non-limiting embodiment the metal surface is low alloy carbon steel and the corrosive environment in contact with the low alloy carbon steel contains carbon dioxide (CO₂). As defined herein, “low alloy” carbon steel is defined as containing about 0.05% sulfur and melts around 1,426 to1,538° C. (2,599-2,800° F.). A non-limiting example of low alloy carbon steel is A36 grade. Suitable low alloy carbon steels include, but are not necessarily limited to, API tubing steel grades such as H40, J55, K55, M65, N80.1, N80.Q, L80.1, C90.1, R95, T95, C110, P110, Q125.1. Pipeline steels that are also of particular interest include, but are not necessarily limited to, X65 and X70. The designation includes seamless proprietary grades with similar compositions.

The corrosion inhibitor additive and/or the corrosion inhibitor (Formulae A and/or A1) may suppress or decrease the amount of and/or the rate of corrosion of the metal surface within the oil and gas carbon steel piping. That is, it is not necessary for corrosion of the metal surface to be entirely prevented for the methods and compositions discussed herein to be considered effective, although complete prevention is a desirable goal. Success is obtained if less corrosion occurs in the presence of the corrosion inhibitor additive and/or the corrosion inhibitor than in the absence of the corrosion inhibitor additive and/or corrosion inhibitor. Alternatively, the methods described are considered successful if there is at least a 30% decrease in corrosion of the metal surfaces within the subterranean formation. Additionally, the methods described herein are applicable where the predominant corrosion process is the dissolution of iron to Fe²⁺. “Predominant” is defined as where at least 50 area % of the corrosion that occurs is due to the dissolution of iron to Fe²⁺. These traditionally occur in systems where the oxygen content is low and redox potential is in the range from 0 to −0.7 Volts with respect to the hydrogen electrode.

The invention will now be described with respect to certain specific examples which are simply meant as non-limiting illustrations thereof and not necessarily limiting of the invention.

### EXAMPLES

### Example 1

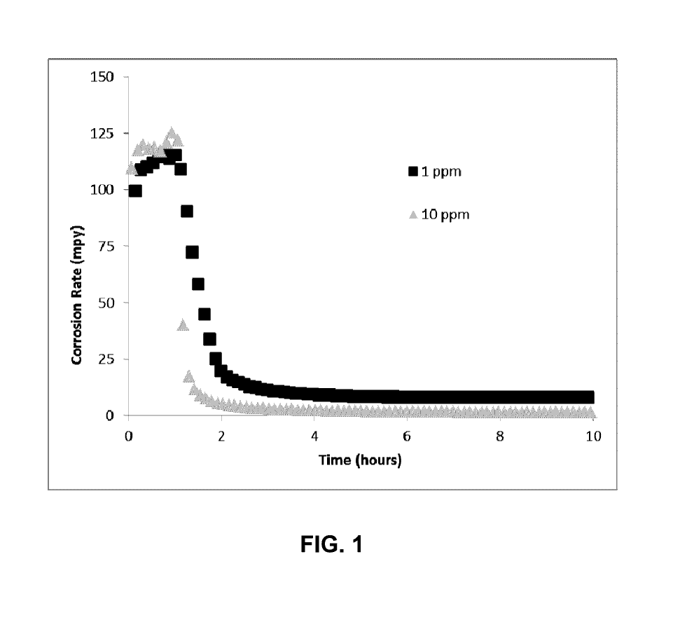

In FIG. 1, the corrosion inhibition performance of SH—CH₂—[CH₂—O—CH₂]₂—CH₂—SH, when z is 2 in Formula A1, at the dosage of 1 ppmv and 10 ppmv based on total fluid amount is shown as a function of time. The total fluid consists of 100 ml ISOPAR™ M hydrocarbon of 900 ml of brine solution, which has about 94 g/L NaCl, 4.1 g/L CaCl₂ and 1.9 g/L MgCl₂. CO₂ was constantly purging through the fluid prior and during the corrosion testing at about 100 mL/min at 1 atm pressure. The temperature was maintained at 180° F. (82 ° C.). The corrosion rate decreased from about 125 mpy to less than 10 mpy, at 1 ppmv dosage and less than 2 mpy, at 10 ppmv dosage after the chemical was injected at hour one.

### Example 2

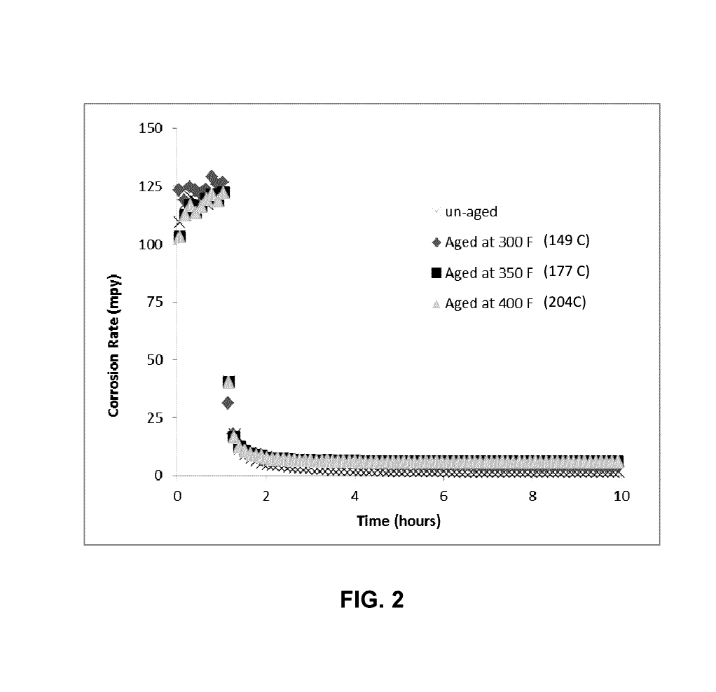

SH—CH₂—[CH₂—O—CH₂]₂—CH₂—SH was thermally aged at different temperatures, for 7 days, prior to injected into the corrosion environment. In FIG. 2, the corrosion inhibition performance of un-aged and aged SH—CH₂—[CH₂—O—CH₂]₂—CH₂—SH were shown. The corrosion testing was conducted as described in Example 1. At 10 ppmv dosage, the chemical's inhibition performance shown no difference when the chemical was exposed to thermal aging at 300° F. (149° C.), 350° F. (177° C.) and 400° F. (204° C.). This indicates this chemical has a thermal stability limit of 400° F., for the exposure time of 7 days.

In the foregoing specification, the invention has been described with reference to specific embodiments thereof, and has been described as effective in providing methods for decreasing corrosion of a metal surface in a high temperature environment. However, it will be evident that various modifications and changes can be made thereto without departing from the broader spirit or scope of the invention as set forth in the appended claims. Accordingly, the specification is to be regarded in an illustrative rather than a restrictive sense. For example, specific first inhibitors, second inhibitors, corrosion inhibitors of Formula (A), downhole fluids, and corrosion forming components falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method for decreasing corrosion of a metal surface in a high temperature environment where less corrosion of the metal surface occurs as compared to an otherwise identical method absent the corrosion inhibitor additive may consist of or consist essentially of incorporating a corrosion inhibitor additive into a corrosive environment within a subterranean formation in an effective amount based on the total amount of the corrosive environment to at least partially decrease corrosion of the metal surface; the corrosion inhibitor additive may comprise, consist essentially of, or consist of, at least one first inhibitor and optionally at least one second inhibitor; where the first inhibitor(s) has the following Formula (A):

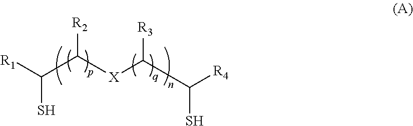

wherein x is oxygen or hydrogenated nitrogen or quaternized nitrogen; R1, R2, R3 and R4 are independently hydrogen, methyl or an alkyl group; p, q and n could be integers from 1 to 100; the second inhibitor(s) may be or include imidazolines, quaternary amines, phosphate esters, and combinations thereof.

The method may consist of or consist essentially of incorporating a corrosion inhibitor into a corrosive environment within a subterranean formation in an effective amount based on the total amount of the corrosive environment to at least partially decrease corrosion of the metal surface; the corrosion inhibitor is represented by Formula (A1):

SH—CH₂—[CH₂—O—CH₂]_{z}—CH₂—SH (A1)

wherein z is an integer ranging from 1 to 100; the corrosion inhibitor may be included in the corrosion inhibitor additive in addition to or in lieu of the first inhibitor(s) in a non-limiting embodiment; the corrosion inhibitor may be used in the absence of the second inhibitor(s).

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

1. A method for decreasing corrosion of a metal surface in a corrosive environment, where the method comprises:
incorporating a corrosion inhibitor additive into a corrosive environment in contact with the metal surface in an effective amount to at least partially decrease corrosion of the metal surface based on the total amount of the corrosive environment; where the corrosion inhibitor additive comprises at least one first inhibitor;
where the at least one first inhibitor has the formula (A): 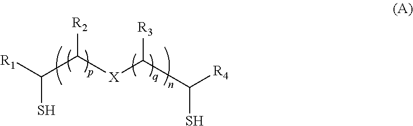
wherein x is oxygen or hydrogenated nitrogen or quaternized nitrogen; R₁, R₂, R₃ and R₄ are independently hydrogen, methyl or an alkyl group; n, p and q are independently integers from 1 to 100; and
where less corrosion of the metal surface occurs as compared to an otherwise identical method absent the corrosion inhibitor additive.

2. The method of claim 1 where the corrosion inhibitor additive comprises at least one second inhibitor is selected from the group consisting of primary amines, secondary amines, tertiary amines, imidazolines, imidazoline derivatives, quaternary amines, phosphate esters, phosphate derivatives, thiol derivatives, pyridine derivatives, organic acids, alkyl alcohols, surfactants such as, oxygen scavengers, and scale inhibitors, and combinations thereof.

3. The method of claim 1, where the corrosive environment is at a temperature ranging from about 100° F. (38° C.) to about 500° F. (260° C.), and where the corrosion inhibitor additive is stable

4. The method of claim 1, where the effective amount of the corrosion inhibitor additive ranges from about 0.01 ppm to about 1,000 ppm based on the total amount of the corrosive environment.

5. The method of claim 4 where carbon dioxide is present in the corrosive environment and the metal surface is a low alloy carbon steel.

6. The method of claim 2, where the molar ratio of the at least one first inhibitor to the at least one second inhibitor within the corrosion inhibitor additive ranges from about 1:100 to about 100:1.

7. The method of claim 1, where the corrosive environment is a downhole fluid, and the method further comprises circulating the downhole fluid into a subterranean formation; where the circulating the downhole fluid occurs at a time selected from the group consisting of: prior to incorporating the corrosion inhibitor additive, after the incorporating the corrosion inhibitor additive, at the same time as incorporating the corrosion inhibitor additive, and combinations thereof, where the downhole fluid is selected from the group consisting of drilling fluids, completion fluids, stimulation fluids, packer fluids, injection fluids, servicing fluids, and combinations thereof.

8. The method of claim 7, where the subterranean formation is part of an offshore well.

9. The method of claim 1, where the metal surface is selected from the group consisting of a pipe, a wellhead, and combinations thereof.

10. A method for decreasing corrosion of a metal surface in a corrosive environment at a temperature ranging from about 100° F. (38° C.) to about 500° F. (260° C.), where the method comprises:
circulating a fluid in the corrosive environment, where the fluid is selected from the group consisting of drilling fluids, completion fluids, stimulation fluids, packer fluids, injection fluids, servicing fluids, and combinations thereof; and
incorporating a corrosion inhibitor additive into the fluid in an amount ranging from about 0.1 ppm to about 1,000 ppm to at least partially decrease corrosion of the metal surface based on the total amount of the corrosive environment; where the corrosion inhibitor additive comprises at least one first inhibitor and a second inhibitor; where the circulating the fluid occurs at a time selected from the group consisting of: prior to incorporating the corrosion inhibitor additive, after the incorporating the corrosion inhibitor additive, at the same time as incorporating the corrosion inhibitor additive, and combinations thereof;
where the at least one first inhibitor has the formula (A): 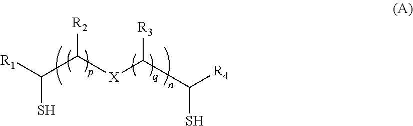
wherein x is oxygen or hydrogenated nitrogen or quaternized nitrogen; R₁, R₂, R₃ and R₄ are independently hydrogen, methyl or an alkyl group, n, p and q are independently integers from 1 to 100;
where the at least one second inhibitor is selected from the group consisting of imidazolines, quaternary amines, phosphate esters, and combinations thereof;
where the corrosion inhibitor is stable, and where less corrosion of the metal surface occurs as compared to an otherwise identical method absent the corrosion inhibitor additive.

11. A method for decreasing corrosion of a metal surface in contact with a corrosive environment, where the method comprises:
incorporating an anti-corrosion additive into the corrosive environment in an effective amount to at least partially decrease corrosion of the metal surface based on the total amount of the corrosive environment; where the corrosion inhibitor is represented by Formula (A1):
SH—CH₂—[CH₂—O—CH₂]_{z}—CH₂—SH (A1)
where z is an integer ranging from 1 to 100.

12. The method of claim 11, where the effective amount of the corrosion inhibitor ranges from about 0.1 ppm to about 10,000 ppm based on the total amount of the corrosive environment.

13. The method of claim 11, further comprising incorporating an effective amount of at least one second inhibitor selected from the group consisting of imidazolines, quaternary amines, phosphate esters, and combinations thereof.

14. The method of claim 13, where the effective amount of the at least one second inhibitor ranges from about 0.1 ppm to about 10,000 ppm based on the total amount of the corrosive environment.

15. The method of claim 11, where the corrosion inhibitor is stable at a temperature ranging from about 200° F. (92° C.) to about 500° F. (260° C.).

16. The method of claim 11, where the corrosive environment is a downhole fluid and the method further comprises circulating the downhole fluid into a subterranean formation; where the circulating the downhole fluid occurs at a time selected from the group consisting of: prior to incorporating the corrosion inhibitor, after the incorporating the corrosion inhibitor, at the same time as incorporating the corrosion inhibitor, and combinations thereof, where the downhole fluid is selected from the group consisting of drilling fluids, completion fluids, stimulation fluids, packer fluids, injection fluids, servicing fluids, and combinations thereof.

17. The method of claim 16, where a temperature of the downhole fluid ranges from about 150° F. (72° C.) to about 500° F. (260° C.).

18. The method of claim 11 where the carbon dioxide is present in the corrosive environment and the metal surface is a low alloy carbon steel.

19. The method of claim 18 when the corrosive environment comprises a packer fluid.

20. The method of claim 18 when the corrosive environment comprises a pipeline or refinery where the corrosive environment comprises a liquid and gaseous environment and a predominant corrosion process is the dissolution of iron to Fe²⁺.
